(19) United States
(12) Patent Application Publication
(10) Pub. No.: US 2004/0149314 A1
(43) Pub. Date: Aug. 5, 2004

(54) Device and method for controlling amount of regenerative water supply to dish washer

(76) Inventors: Ki Chul Cha, Changwon-si (KR); Myong Ho Kang, Busan (KR)

Correspondence Address: BIRCH STEWART KOLASCH & BIRCH, PO BOX 747, FALLS CHURCH, VA, 22040-0747, US

(21) Appl. No.: 10/718,625

(22) Filed: Nov. 24, 2003

(30) Foreign Application Priority Data
Nov. 25, 2002 (KR) P2003-073613

(51) Int. Cl. B08B 7/04

(52) U.S. Cl. 134/18; 134/56 D

(57) ABSTRACT

Device and method for controlling an amount of regenerative water supply to a dish washer, the method including the steps of receiving a hardness value of washing water intended to use, retrieving, and displaying a time period of regenerative water supply relevant to a received hardness value of the washing water, and supplying the regenerative water to the ion exchange resin for the retrieved time period of regenerative water supply.

This application claims the benefit of the Korean Application No. P2002-0073613 filed on Nov. 25, 2002, which is hereby incorporated by reference.

### BACKGROUND OF THE INVENTION

1. Field of the Invention

The present invention relates to dish washers, and more particularly, to device and method for controlling an amount of regenerative water supply to a dish washer.

2. Background of the Related Art

In general, the dish washer automatically carries out washing, rinsing, and drying cycles by loading dishes to be washed on a rack, and spraying washing water supplied from an outside of the dish washer, or heated with an internal heater through spray nozzles according to a washing algorithm.

Referring to FIG. 1, a related art dish water is provided with an upper rack 4 and a lower rack 6 in a tub 1 for loading dishes thereon, a sump 2 under the tub 1 for storing washing water, a washing pump 3 for pumping up the washing water from the sump 2, a washing water pipe 8 connected to the washing pump 3 for guiding flow of the washing water, and upper spray nozzles 5 and a lower spray nozzles 7 connected to the washing water pipe 8 for spraying washing water to the upper 4 and the lower 6.

In the related art dish washer, the washing 3 is connected such that the washing water drawn up from the 2 can be sprayed through the upper and lower spray nozzles 5 and 7 via a washing water heater (not shown).

There is a steam suction (not shown) in a door part 9, having a fan (not shown) mounted thereon for discharging steam from the dish washer to an outside of the dish washer through the steam suction during the drying cycle.

The washing water introduced into the dish washer from a water supply valve (not shown) is stored in the 2 through a softener (not shown). The softener removes hard water components (calcium ions, magnesium ions, and etc.) from the washing water, to reduce hardness of the washing water, for dissolving detergent well, and removing ion components that can deposit on the tub or the dishes. The removal of the hard water components from the washing water is made by ion exchange reaction when the washing water passes through ion exchange resin in the softener.

However, if the performance of the ion exchange resin in the softener degrades, regenerative water, such as salt water, is supplied to the ion exchange resin, to restore the performance of the ion exchange resin in the softener. In this instance, an amount of the regenerative water to be supplied to the ion exchange resin is determined according to hardness of the washing water.

Therefore, the user has personally regulated a regenerative water flow control device for supplying an amount of regenerative water relevant to the hardness of the washing water. That is, referring to the hardness of the washing water published by a regional water work station, the user determines the amount of regenerative water to be supplied to the ion exchange resin, and controls the regenerative water flow control device, such that the regenerative water flow control device controls open/close time periods of a regenerative water outlet (not shown).

However, the user's manual input of the amount of regenerative water to the regenerative water flow control device according to the hardness of the washing water is complicate and inconvenient.

Moreover, the user's determination of the amount of regenerative water with reference to the hardness of the washing water published by the regional water work station, and manual control of the regenerative water flow control device causes inaccurate supply of the regenerative water amount.

### SUMMARY OF THE INVENTION

Accordingly, the present invention is directed to device and method for controlling an amount of regenerative water supply to a dish washer that substantially obviates one or more of the problems due to limitations and disadvantages of the related art.

An object of the present invention is to provide device and method for controlling an amount of regenerative water supply to a dish washer, which can control an amount of regenerative water supply, accurately and conveniently.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these objects and other advantages and in accordance with the purpose of the present invention, as embodied and broadly described herein, the device for controlling an amount of regenerative water to a dish washer having ion exchange resin for dropping hardness of washing water, and a regenerative water supply part for supplying regenerative water to restore a performance of the ion exchange resin, includes a memory part for storing information on hardness values of washing water and time periods of regenerative water supply relevant to the hardness values, an input part for providing the hardness value of the washing water intended to use, a display part for displaying information on a provided hardness value of washing water and the time period of regenerative water supply relevant to the hardness value, and a controlling part for retrieving the time period of regenerative water supply relevant to the provided hardness value of the washing water from the memory part, controlling the display part to display a retrieved time period of regenerative water supply, and controlling the regenerative water supply part to supply the regenerative water for the time period of regenerative water supply.

The input part has a form of a knob, and the hardness value of the washing water decreases if the knob is turned to left, and the hardness value of the washing water increases if the knob is turned to right.

In other aspect of the present invention, there is provided a method for controlling an amount of regenerative water to a dish washer, including the steps of receiving a hardness value of washing water intended to use, retrieving, and displaying a time period of regenerative water supply relevant to a received hardness value of the washing water, and supplying the regenerative water to the ion exchange resin for the retrieved time period of regenerative water supply.

The step for receiving a hardness value of washing water intended to use includes the steps of determining if a cycle mode selected by a user is a mode for setting an amount of regenerative water supply, displaying an initial hardness value of the washing water if the cycle mode selected by the user is the mode for setting an amount of regenerative water supply, receiving a new hardness value of the washing water, determining if the received hardness value of the washing water is definitive, and storing a definitive hardness value of the washing water, if the hardness value of the washing water is definitive.

The step for receiving a hardness value of washing water intended to use further includes the step of carrying out no mode for setting an amount of regenerative water supply, if the cycle mode selected by the user is not the mode for setting an amount of regenerative water supply, after the step of determining if a cycle mode selected by a user is a mode for setting an amount of regenerative water supply. The step for receiving a hardness value of washing water intended to use further includes the step of repeating the step of receiving a new hardness value of the washing water, if the hardness value of the washing water is not definitive, after the step of determining if the received hardness value of the washing water is definitive.

The step of retrieving, and displaying a time period of regenerative water supply relevant to a received hardness value of the washing water includes the steps of determining if a cycle mode selected by the user is a dish washing mode, retrieving a stored definitive hardness value of the washing water, if the cycle mode selected by the user is the dish washing mode, retrieving a time period of regenerative water supply relevant to a retrieved definitive hardness value of the washing water, and displaying the retrieved time period of regenerative water supply.

The step of retrieving, and displaying a time period of regenerative water supply relevant to a received hardness value of the washing water further includes the steps of stopping operation of controlling an amount of regenerative water supply after step of determining if a cycle mode selected by the user is a dish washing mode, if the cycle mode selected by the user is not the dish washing mode.

It is to be understood that both the foregoing description and the following detailed description of the present invention are exemplary and explanatory and are intended to provide further explanation of the invention claimed.

### BRIEF DESCRITPION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a section of a related art dish washer;

FIG. 2 illustrates a block diagram of a device for controlling an amount of regenerative water to a dish washer in accordance with a preferred embodiment of the present invention;

FIG. 3 illustrates the input part and the display part in FIG. 2; and

FIG. 4 illustrates a flow chart showing the steps of a method for controlling an amount of regenerative water supply to a dish washer in accordance with a preferred embodiment of the present invention.

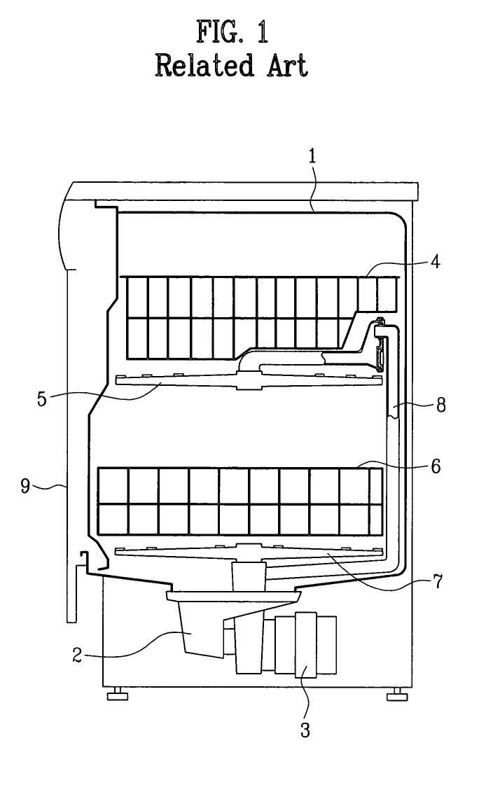

### DETAILED DESCRIPTION OF THE PREFERRED EMBODIMENT

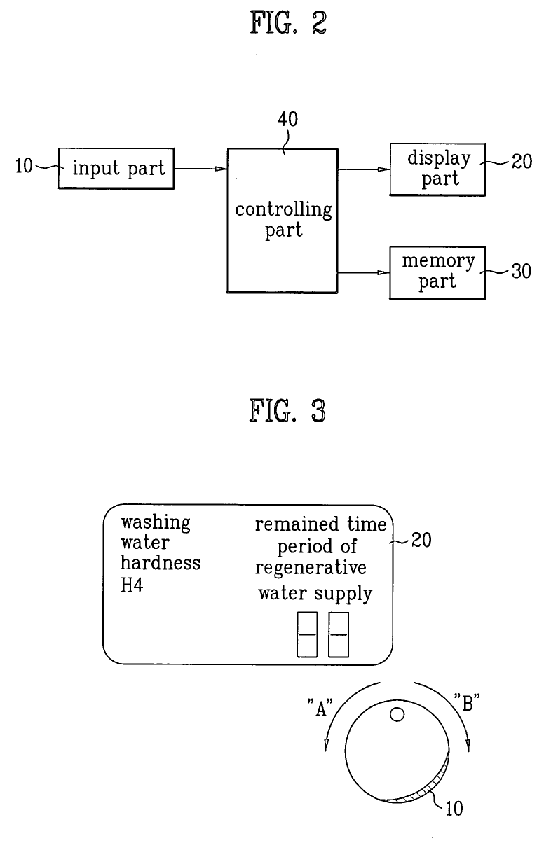

Reference will now be made in detail to the preferred embodiments of the present invention, examples of which are illustrated in the accompanying drawings. FIG. 2 illustrates a block diagram of a device for controlling an amount of regenerative water to a dish washer in accordance with a preferred embodiment of the present invention.

Referring to FIG. 2, the device for controlling an amount of regenerative water to a dish washer includes an input part 10, a display part 20, a memory part 30, and a controlling part 40.

Though not shown, the device may further include ion exchange resin for dropping hardness of washing water, and a regenerative water supply part for supplying regenerative water to restore a performance of the ion exchange resin.

The input part 10 may have a knob for providing hardness of washing water the user intends to use thereto. FIG. 3 illustrates the input part and the display part in FIG. 2. As shown, though the input part 10 has a knob form, the input part 10 may be other forms according to convenience of use. When the knob is turned to left, a hardness value decreases, and turned to right, the hardness value increases.

That is, when it is assumed that an initial hardness value is ‘H4’, if the input part 10 is turned in an “A” direction, the hardness value is displayed on the display part 20 in an order of H4→H3→H2→H1→H0→H7→H6→H5→ - - - , and if the input part 10 is turned in a “B” direction, the hardness value is displayed on the display part in an order of H4→H5→H6→H7→H0→H1→H2→H3→ - - - .

Together with this, as shown in FIG. 3, the display part 20 displays information on the hardness value of washing water provided thereto, and a supply time period of the regenerative water relevant to the hardness value.

The memory part 30 stores the information on the hardness value of washing water, and the supply time period of the regenerative water. The memory part 30 has the following table 1 of the hardness value of washing water versus the supply time period of the regenerative water stored therein.

TABLE 1

| | Hardness | | | | | | | |
|---|---|---|---|---|---|---|---|---|
| | H0 | H1 | H2 | H3 | H4 | H5 | H6 | H7 |
| Regenerative | 0 | 7 | 13 | 20 | 28 | 36 | 45 | 55 |
| water supply time period (second) | | | | | | | | |

The controlling part 40 retrieves the regenerative water supply time period relevant to the hardness value of the washing water provided thereto from the memory 30, and controls the display part 20 to display the regenerative water supply time period thereon, and the regenerative water supply part to supply the regenerative water for the regenerative water supply time period.

During the supply of regenerative water, the controlling part 40 controls open/close time of the regenerative water outlet according to the regenerative water supply time period relevant to the hardness value of the washing water preset thereto. For an example, if the user set the hardness value of the washing water to ‘H2’ with the input part 10, the controlling part 40 opens the regenerative water outlet for 13 seconds relevant to ‘H2’, for supplying the regenerative water thereto. (see TABLE 1).

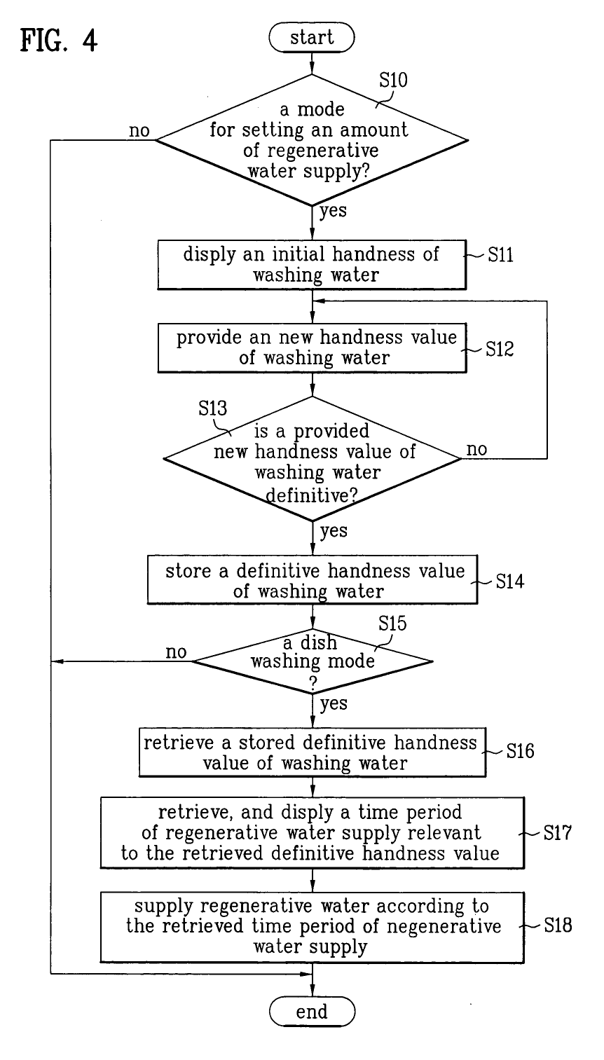

A method for controlling an amount of regenerative water supply to a dish washer in accordance with a preferred embodiment of the present invention will be described. FIG. 4 illustrates a flow chart showing the steps of a method for controlling an amount of regenerative water supply to a dish washer in accordance with a preferred embodiment of the present invention.

Referring to FIG. 4, the controlling part determines if a cycle mode selected by the user is a mode for setting an amount of regenerative water supply. (S10). As a result of the determination, if the cycle mode selected by the user is a mode for setting an amount of regenerative water supply, the display part displays an initial hardness value of washing water in response to a control signal from the controlling part. (S11).

However, as the result of the determination, if the cycle mode selected by the user is not the mode for setting an amount of regenerative water supply, the controlling part does not carries out the mode for setting an amount of regenerative water supply.

Then, the controlling part is provided with a new hardness value of the washing water from the user through the input part. (S12). Then, the controlling part determines if the hardness value of the washing water provided thereto is definitive. (S13). As a result of the determination, if the hardness value of the washing water is definitive, the control part stores the definitive hardness value of the washing water in a memory part. (S14). However, as the result of the determination, if the hardness value of the washing water is not definitive, the step for being provided with a new hardness value is repeated.

Then, the controlling part determines if the cycle mode selected by the user is a dish washing mode. (S15). As a result of the determination, if the cycle mode selected by the user is the dish washing mode, the controlling part retrieves the definitive hardness value of the washing water from the memory part. (S16). However, as the result of the determination, if the cycle mode selected by the user is not the dish washing mode, the controlling part stops the operation for controlling an amount of regenerative water supply.

Then, the controlling part retrieves a time period of the regenerative water supply relevant to the retrieved definitive hardness value of the washing water, and displays on the display part. (S17).

Then, the controlling part supplies the regenerative water to the ion exchange resin according to the retrieved time period of the regenerative water supply, and finishes the operation for controlling an amount of regenerative water supply. (S18).

Thereafter, washing, rinsing, and drying cycles may be carried out proper to cycle modes.

Thus, if a hardness value of washing water intended to use is provided, the device and method for controlling an amount of regenerative water supply to a dish washer of the present invention can control a time period for supplying regenerative water, i.e., an amount of regenerative water supply, relevant to the hardness value, automatically.

Accordingly, the device and method for controlling an amount of regenerative water supply to a dish washer has a simple operation and convenient, because an amount of regenerative water supply is controlled automatically once the user inputs the hardness value of the washing water intended to use.

Moreover, since an amount of regenerative water supply is controlled automatically once the user inputs the hardness value of the washing water intended to use, accurate control of an amount of regenerative water supply is made possible, thereby improving a reliability of the product.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A device for controlling an amount of regenerative water to a dish washer having ion exchange resin for dropping hardness of washing water, and a regenerative water supply part for supplying regenerative water to restore a performance of the ion exchange resin, comprising:
a memory part for storing information on hardness values of washing water and time periods of regenerative water supply relevant to the hardness values;
an input part for providing the hardness value of the washing water intended to use;
a display part for displaying information on a provided hardness value of washing water and the time period of regenerative water supply relevant to the hardness value; and
a controlling part for retrieving the time period of regenerative water supply relevant to the provided hardness value of the washing water from the memory part, controlling the display part to display a retrieved time period of regenerative water supply, and controlling the regenerative water supply part to supply the regenerative water for the time period of regenerative water supply.

2. The device as claimed in claim 1, wherein the input part has a form of a knob.

3. The device as claimed in claim 2, wherein the hardness value of the washing water decreases if the knob is turned to left, and the hardness value of the washing water increases if the knob is turned to right.

4. A method for controlling an amount of regenerative water to a dish washer having ion exchange resin for dropping hardness of washing water, and a regenerative water supply part for supplying regenerative water to restore a performance of the ion exchange resin, the method comprising the steps of:
receiving a hardness value of washing water intended to use;
retrieving, and displaying a time period of regenerative water supply relevant to a received hardness value of the washing water; and
supplying the regenerative water to the ion exchange resin for the retrieved time period of regenerative water supply.

5. The method as claimed in claim 4, wherein the step for receiving a hardness value of washing water intended to use includes the steps of;
determining if a cycle mode selected by a user is a mode for setting an amount of regenerative water supply,
displaying an initial hardness value of the washing water if the cycle mode selected by the user is the mode for setting an amount of regenerative water supply,
receiving a new hardness value of the washing water,
determining if the received hardness value of the washing water is definitive, and
storing a definitive hardness value of the washing water, if the hardness value of the washing water is definitive.

6. The method as claimed in claim 5, wherein the step for receiving a hardness value of washing water intended to use further includes the step of;
carrying out no mode for setting an amount of regenerative water supply, if the cycle mode selected by the user is not the mode for setting an amount of regenerative water supply, after the step of determining if a cycle mode selected by a user is a mode for setting an amount of regenerative water supply.

7. The method as claimed in claim 5, wherein the step for receiving a hardness value of washing water intended to use further includes the step of;
repeating the step of receiving a new hardness value of the washing water, if the hardness value of the washing water is not definitive, after the step of determining if the received hardness value of the washing water is definitive.

8. The method as claimed in claim 4, wherein the step of retrieving, and displaying a time period of regenerative water supply relevant to a received hardness value of the washing water includes the steps of;
determining if a cycle mode selected by the user is a dish washing mode,
retrieving a stored definitive hardness value of the washing water, if the cycle mode selected by the user is the dish washing mode,
retrieving a time period of regenerative water supply relevant to a retrieved definitive hardness value of the washing water, and
displaying the retrieved time period of regenerative water supply.

9. The method as claimed in claim 8, wherein the step of retrieving, and displaying a time period of regenerative water supply relevant to a received hardness value of the washing water further includes the steps of;
stopping operation of controlling an amount of regenerative water supply after step of determining if a cycle mode selected by the user is a dish washing mode, if the cycle mode selected by the user is not the dish washing mode.

10. A method for controlling an amount of regenerative water to a dish washer having ion exchange resin for dropping hardness of washing water, and a regenerative water supply part for supplying regenerative water to restore a performance of the ion exchange resin, the method comprising the steps of:
determining if a cycle mode selected by a user is a mode for setting an amount of regenerative water supply,
displaying an initial hardness value of the washing water if the cycle mode selected by the user is the mode for setting an amount of regenerative water supply,
receiving a new hardness value of the washing water,
determining if the received hardness value of the washing water is definitive,
storing a definitive hardness value of the washing water, if the hardness value of the washing water is definitive,
determining if a cycle mode selected by the user is a dish washing mode,
retrieving a stored definitive hardness value of the washing water, if the cycle mode selected by the user is the dish washing mode,
retrieving a time period of regenerative water supply relevant to a retrieved definitive hardness value of the washing water,
displaying the retrieved time period of regenerative water supply, and
supplying the regenerative water to the ion exchange resin according to the retrieved time period of regenerative water supply.

11. The method as claimed in claim 10, wherein the step for receiving a hardness value of washing water intended to use further includes the step of;
carrying out no mode for setting an amount of regenerative water supply, if the cycle mode selected by the user is not the mode for setting an amount of regenerative water supply, after the step of determining if a cycle mode selected by a user is a mode for setting an amount of regenerative water supply.

12. The method as claimed in claim 10, wherein the step for receiving a hardness value of washing water intended to use further includes the step of;
repeating the step of receiving a new hardness value of the washing water, if the hardness value of the washing water is not definitive, after the step of determining if the received hardness value of the washing water is definitive.

13. The method as claimed in claim 10, wherein the step of retrieving, and displaying a time period of regenerative water supply relevant to a received hardness value of the washing water further includes the steps of;
stopping operation of controlling an amount of regenerative water supply after step of determining if a cycle mode selected by the user is a dish washing mode, if the cycle mode selected by the user is not the dish washing mode.
